(19) United States
(12) Patent Application Publication
(10) Pub. No.: US 2011/0199309 A1
(43) Pub. Date: Aug. 18, 2011

(54) Input Device

(75) Inventor: Wei-Pin Chuang, Taipei City (TW)

(73) Assignee: COMPAL ELECTRONICS, INC., Taipei City (TW)

(21) Appl. No.: 12/971,225

(22) Filed: Dec. 17, 2010

(30) Foreign Application Priority Data
Feb. 12, 2010 (TW) 99104829

(51) Int. Cl. G06F 3/02; G06F 3/041

(52) U.S. Cl. 345/168; 345/173

(57) ABSTRACT

An input device adapted in a computer system is disclosed herein. The input device includes a keyboard, a touch pad and a switching module. The keyboard comprises two space bars. The touch pad senses a touch input. The switching module is placed in a controller and is connected to the keyboard and the touch pad. The switching module switches the function of the two space bars between a command-input function and a space-bar-input function.

### RELATED APPLICATIONS

This application claims priority to Taiwan Application Serial Number 99104829, filed Feb. 12, 2010, which is herein incorporated by reference.

### BACKGROUND

1. Technical Field

The present invention relates to an electronic device. More particularly, the present invention relates to an input device and a method for switching the function of the input device.

2. Description of Related Art

Input device is an important interface for the communication between the user and the computer system. The user is able to input the command to the computer system through the input device and make the computer system perform the processing of the data and the interchange of the information.

The most popular input devices are mouse, keyboard and touch pad. However, these input devices are stand-alone input devices and are not integrated together. The separated input devices are not convenient for the users.

Accordingly, what is needed is a new design of the input device to make the integration of different kinds of input devices possible. The present disclosure addresses such a need.

### SUMMARY

An input device adapted in a computer system is disclosed herein. The input device includes a keyboard, a touch pad and a switching module. The keyboard includes two space bars. The touch pad senses a touch input. The switching module is placed in a controller and is connected to the keyboard and the touch pad. The switching module switches the function of the two space bars between a command-input function and a space-bar-input function.

Another aspect of the present disclosure is to provide a method to switch the function of an input device comprising the steps as follow. A keyboard adapted in a computer system is provided, wherein the keyboard comprises two space bars. Whether a touch input is sensed is determined according to a touch pad adapted in the computer system. The function of the two space bars is switched between a command-input function and a space-bar-input function according to the result of the determining step by using a switching module located in a controller, wherein the switching module is connected to the keyboard and the touch pad.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a top view of an input device of an embodiment of the present disclosure;

FIG. 2 is a block diagram of the input device in FIG. 1;

FIG. 3 is a top view of the input device in another embodiment of the present disclosure; and

FIG. 4 is a flow chart of a method to switch the function of an input device of an embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

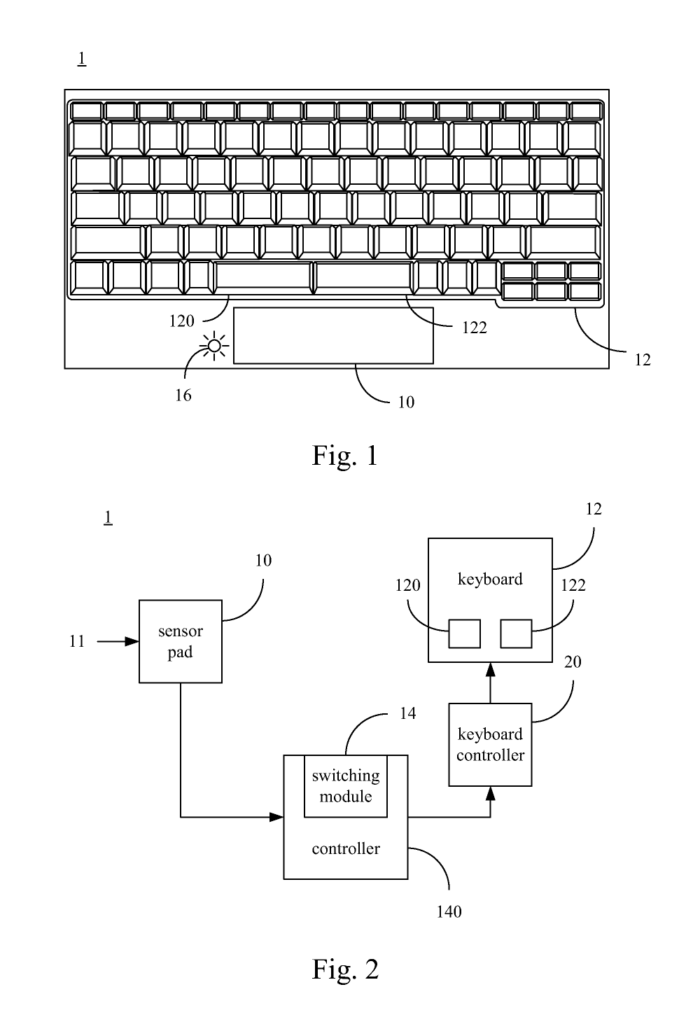

Please refer to FIG. 1. FIG. 1 is a top view of an input device 1 of an embodiment of the present disclosure. The input device 1 is adapted in a computer system (not shown). The input device 1 comprises a touch pad 10 and a keyboard 12. The keyboard 12 comprises a plurality of keys.

Please refer to FIG. 2 at the same time. FIG. 2 is a block diagram of the input device 1 in FIG. 1. Besides the touch pad 10 and the keyboard 12, the input device 1 further comprises a switching module 14. The switching module 14 is located in a controller 140. In an embodiment, the controller 140 is an embedded controller. In an embodiment, the switching module 14 can be a hardware module independent of the controller 140. In the present embodiment, the switching module 14 is a control process of the controller 140. The keyboard 12 comprises two space bars 120 and 122. The space bar 120 is the first space bar 120 and the space bar 122 is the second space bar 122. The controller 140 is connected to the touch pad 10 and the keyboard 12. In an embodiment, the controller 140 is connected to the keyboard 12 through a keyboard controller 20. The keyboard controller 20 is able to perform a conversion of the signal from the keyboard 12 and further transmit the signal to the controller 140, wherein the keyboard controller 20 in an embodiment is located in the controller 140 as well.

The touch pad 10 is used to sense a touch input 11. The switching module 14 located in the controller 140 switches the function of the two space bars 120 and 122 between a command-input function and a space-bar-input function through the keyboard controller 20 according to the touch input 11. When the touch pad 10 senses the touch input 11, a displacement direction of a cursor on a screen (not shown) of the computer system is controlled according to the touch input 11. Further, the switching module 14 makes the two space bars 120 and 122 perform the command-input function for a specific time interval. In an embodiment, the command-input function is inputs corresponding to click the left key and the right key of the mouse.

For instance, the first space bar 120 can perform the function of the left click of the mouse and the second space bar 122 can perform the function of the right click of the mouse. Consequently, when the touch pad 10 senses the touch input 11, the switching module 14 makes the two space bars 120 and 122 perform the mouse click function for a specific time interval to control the graphic user interface on the screen of the computer system.

On the other hand, when the touch pad 10 doesn't sense the touch input 11 in the specific time interval, the switching module 14 located in the controller 140 makes the two space bars 120 and 122 perform the space-bar-input function through the keyboard controller 20. Usually, the user is not controlling the graphic user interface when there is no touch input 11. As a result, the switching module 14 makes the two space bars 120 and 122 perform the space-bar-input function.

The “specific time interval” described above can be in the range between 3 to 5 seconds. In other embodiments, different durations of the time interval can be set in order to provide the user a more efficient way to control the computer system.

In an embodiment, the input device 1 further comprises an indication light 16 as depicted in FIG. 1. When the touch pad 10 senses the touch input 11, the switching module 14 located in the controller 140 makes the indication light 16 show a first light signal and makes the two space bars 120 and 122 perform the command-input function, which is the mouse click function, for a specific time interval. When the touch pad 10 doesn't sense the touch input 11 in the specific time interval, the switching module 14 located in the controller 140 makes the indication light 16 show a second light signal and makes the two space bars 120 and 122 perform the space-bar-input function. For example, the indication light 16 turns on when touch pad 10 senses the touch input 11 and turns off when the touch pad 10 doesn't sense the touch input 11 in the specific time interval.

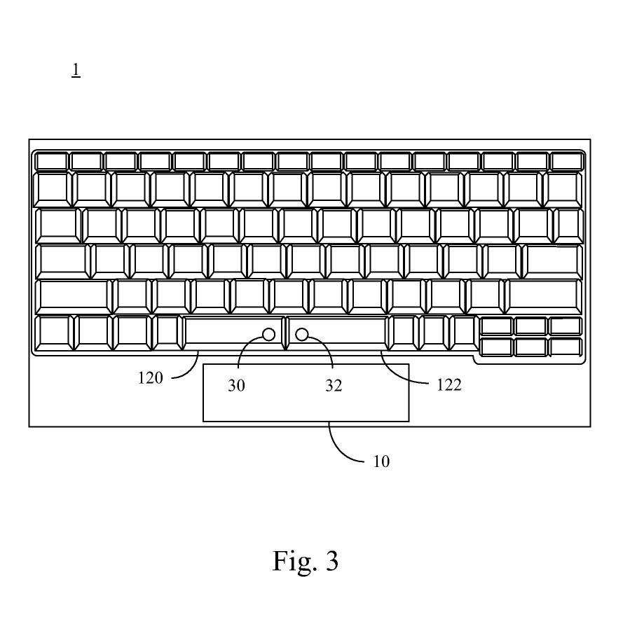

Please refer to FIG. 3. FIG. 3 is a top view of the input device 1 in another embodiment of the present disclosure. In the present embodiment, the input devices comprises a first indication light 30 and a second indication light 32 located on the two space bars 120 and 122 respectively. When the touch pad 10 senses the touch input 11, the switching module 14 located in the controller 140 makes the first and the second indication lights 30 and 32 turn on. When the touch pad 10 doesn't sense the touch input 11 in the specific time interval, the switching module 14 located in the controller 140 makes the first and the second indication lights 30 and 32 turn off.

The input device 1 described above can make the two space bars 120 and 122 switch between the command-input function and the space-bar-input function according to the sensing result of the touch pad 10. Further, the indication light can indicate to the user which function the space bars are performing.

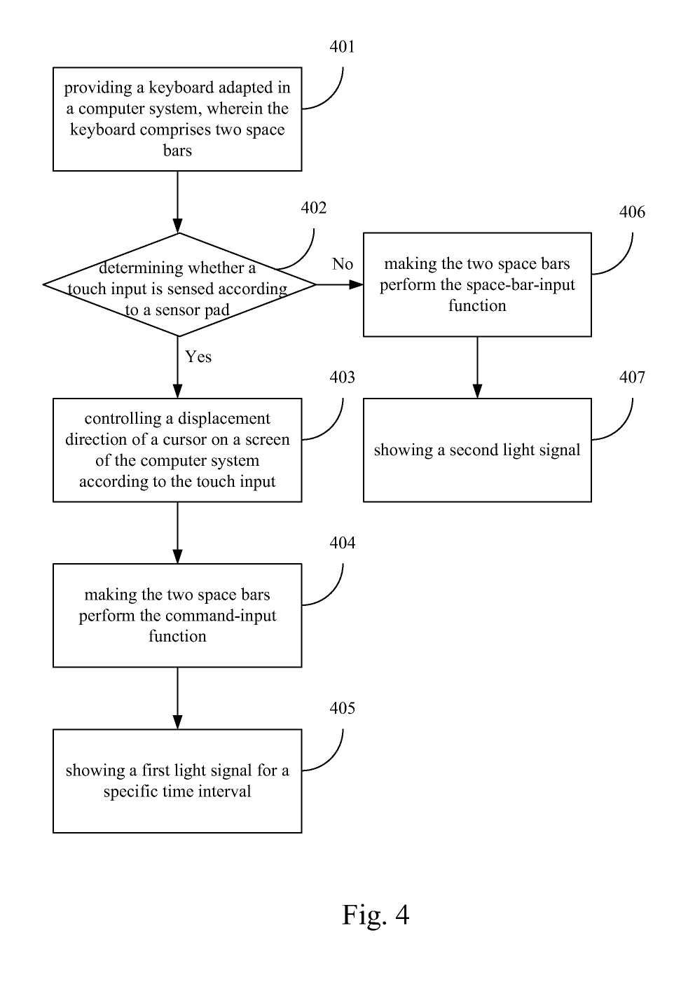

Please refer to FIG. 4. FIG. 4 is a flow chart of a method to switch the function of an input device of an embodiment of the present disclosure. The method can be adapted in the input device 1 depicted in FIG. 1 to FIG. 3. The method comprises the steps as follow. In step 401, a keyboard adapted in a computer system is provided, wherein the keyboard comprises two space bars. In step 402, whether a touch input 11 is sensed is determined according to a touch pad 10 adapted in the computer system. When the touch pad 10 senses the touch input 11, step 403 is performed such that a displacement direction of a cursor on a screen (not shown) of the computer system is controlled according to the touch input 11. Further, in step 404, the switching module 14 makes the two space bars 120 and 122 perform the command-input function. Then in step 405, the indication light shows the first light signal for a specific time interval. In an embodiment, the command-input function is a mouse click function during the specific time interval.

On the other hand, when the touch pad 10 doesn't sense the touch input 11 in the specific time interval, step 406 is performed such that the switching module 14 located in the controller 140 makes the two space bars 120 and 122 perform the space-bar-input function. Then in step 407, the indication light shows a second light signal.

The input device disclosed herein can make the two space bars switch between the command-input function and the space-bar-input function according to the sensing result of the touch pad. Further, the indication light can indicate to the user which function the space bars are performing. Furthermore, the size of the computer system is smaller because of the integration of the input device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. An input device adapted in a computer system comprising:
a keyboard comprising two space bars;
a touch pad to sense a touch input; and
a switching module placed in a controller and is connected to the keyboard and the touch pad, wherein the switching module switches the function of the two space bars between a command-input function and a space-bar-input function.

2. The input device of claim 1, wherein when the touch pad senses the touch input, a displacement direction of a cursor on a screen of the computer system is controlled according to the touch input.

3. The input device of claim 1, wherein when the touch pad senses the touch input, the switching module makes the two space bars perform the command-input function for a specific time interval.

4. The input device of claim 3, wherein when the touch pad doesn't sense the touch input in the specific time interval, the switching module makes the two space bars perform the space-bar-input function.

5. The input device of claim 1, wherein the controller is an embedded controller.

6. The input device of claim 1, wherein the switching module is connected to the keyboard through a keyboard controller to control the function of the two space bars through the keyboard controller.

7. The input device of claim 1, further comprising at least one indication light, wherein when the touch pad senses the touch input, the switching module makes the indication light show a first light signal and when the touch pad doesn't sense the touch input during the specific time interval, the switching module makes the indication light show a second light signal.

8. The input device of claim 7, wherein the indication light is located on the space bars.

9. The input device of claim 1, wherein the command-input function is inputs corresponding to click a left key and a right key of a mouse.

10. A method to switch the function of an input device comprising the steps of:
providing a keyboard adapted in a computer system, wherein the keyboard comprises two space bars;
determining whether a touch input is sensed according to a touch pad adapted in the computer system; and
switching the function of the two space bars between a command-input function and a space-bar-input function according to the result of the determining steps by using a switching module located in a controller, wherein the switching module is connected to the keyboard and the touch pad.

11. The method of claim 10, when the touch pad senses the touch input, the input device shows a light signal.

12. The method of claim 11, wherein the light signal is shown on the space bars.

13. The method of claim 10, wherein the command-input function is inputs corresponding to click a left key and a right key of a mouse.

14. The method of claim 10, wherein when the touch pad senses the touch input, the switching module makes the two space bars perform the command-input function for a specific time interval.

15. The method of claim 14, wherein when the touch pad doesn't sense the touch input in the specific time interval, the switching module makes the two space bars perform the space-bar-input function.

16. The method of claim 10, wherein the controller is an embedded controller.

17. The method of claim 10, wherein the switching module is connected to the keyboard through a keyboard controller to control the function of the two space bars through the keyboard controller.
